(19) United States
(12) Patent Application Publication
(10) Pub. No.: US 2006/0028925 A1
(43) Pub. Date: Feb. 9, 2006

(54) Processing scheme for domain expansion rom media

(75) Inventor: Gavin Nicholas Phillips, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/532,905

(22) PCT Filed: Oct. 7, 2003
(86) PCT No.: PCT/IB03/04444

§ 371 Date: Apr. 27, 2005

(30) Foreign Application Priority Data
Nov. 1, 2002 (EP) 02079592.8

(51) Int. Cl. G11B 11/00

(52) U.S. Cl. 369/13.02; 369/13.06

(57) ABSTRACT

The present invention relates to a domain expansion storage medium and processing method for processing a substrate (40) of such a storage medium with improved efficiency. The surface structure of a substrate of the storage medium is processed by an ion beam projection lithography using a stencil mask to define magnetic domains in a storage layer (50) and/or track patterns and/or servo patterns. Thereby, replication accuracy and speed can be improved.

The present invention relates to a read-only domain expansion storage media and a processing scheme for processing a substrate of such media in which a magnetic wall is displaced to thereby enlarge a magnetic domain so as to reproduce an information indicated by the magnetic domain.

In magneto-optical storage systems, the minimum width of the recorded marks is determined by the diffraction limit, i.e. by the Numerical Aperture (NA) of the focussing lens and the laser wavelength. A reduction of the width is generally based on shorter wavelength lasers and higher NA focussing optics. The capability of writing extremely small domains is essential to increasing areal storage densities in magneto-optical (MO) media. Domain expansion media typically consist of a polycarbonate substrate, a reflective heat conducting layer, a first dielectric layer, a magnetically hard e.g. TbFeCo storage layer which is coupled either magnetostatically through a second dielectric layer or directly via exchange coupling through intermediate magnetic layers to a magnetically soft e.g. GdFeCo read-out layer, a third dielectric layer and/or an acrylic resin cover layer. Data storage is achieved by using a thermomagnetic writing technique whereby the thin storage layer having a thickness of about 20 nm is heated to the Curie temperature by a focussed laser or other radiation spot, and then allowed to cool down in the presence of a magnetic field. The heated area is thereby “frozen” with a magnetic orientation parallel to that of the magnetic field. Fortunately, writing is a thermal process which is not limited to the spot size of the laser, but rather to the size of the heated area. Currently, the ability to write small domains far exceeds the ability to read them. Writing is achieved by modulating either the laser power, e.g. in Light Intensity Modulation (LIM), the external field, e.g. in Magnetic Field Modulation (MFM), or both, e.g. in Laser Pumped MFM (LP-MFM). Data retrieval is achieved via domain expansion whereby a domain written in the storage layer is copied to the read-out layer where it expands to fill the optical read-out spot.

MAMMOS (Magnetic AMplifying Magneto-Optical System) is a domain expansion method based on magneto-statically coupled storage and readout layers, wherein a magnetic field modulation is used for expansion and collapse of expanded domains in the readout layer. A written mark from the storage layer with high coercivity is copied to the readout layer with low coercivity, upon laser heating with the help of an external magnetic field. Due to the low coercivity of this readout layer, the copied mark will expand to fill the optical spot and can be detected with a saturated signal level which is independent of the mark size. Reversal of the external magnetic field collapses the expanded domain. A space in the storage layer, on the other hand, will not be copied and no expansion occurs. Therefore, no signal will be detected in this case.

Domain Wall Displacement Detection (DWDD) is another DomEx method based on an exchange-coupled storage and readout layer, proposed by T. Shiratori et al. in Proc. MORIS '97, J. Magn. Soc. Jpn., 1998, Vol. 22, Supplement No. S2, pp. 47-50. In a DWDD medium, marks recorded in the storage layer are transferred to a displacement layer via an intermediate switching layer as a result of exchange coupling forces. The temperature rises when reproducing laser spots are irradiated onto the discs recording tracks. When the switching layer exceeds the Curie temperature, the magnetization is lost, causing the exchange coupling force between each layer to disappear. The exchange coupling force is one of the forces holding the transferred marks in the displacement layer. When it disappears, the domain wall surrounding the recorded marks shifts to a high temperature section which has low domain wall energy, allowing small recorded marks to expand. The domain wall which had been transferred into the displacement layer shifts as if being pulled by a rubber band. This allows reading via laser beam, even if recordings have been made at high density.

Domain expansion techniques such as MAMMOS and DWDD thus allow readout of bits much smaller than the size of the optical spot, but with a signal much larger than in MSR. The various disk stacks always comprise a recording layer and a readout layer, which may be coupled magneto-statically or by means of exchange coupling. RF MAMMOS requires a modulating external magnetic field during readout, which increases the power consumption, but also allows readout at very high densities and with large signals. Alternative techniques like ZF MAMMOS and DWDD require no external magnetic field during readout, but are expected to be limited to somewhat lower densities, smaller signals and lower data rates.

Present domain expansion technology is restricted to re-writable disks. However, a ROM domain expansion solution by which data cannot be freely written to the domain expansion medium or disk does not exist. In families of optical storage media, the ROM (Read Only Memory) format is seen as an addition used for cheap and fast reproduction of pre-recorded data. These properties of ROM are considered essential for the success of an optical storage product-family. In the case of domain expansion media, a ROM solution is not trivial. The reason is that data is defined by magnetization directions in the storage layer, which are not easily reproduced in pre-recorded media, e.g. by injection moulding.

Documents U.S. Pat. No. 5,993,937 and EP 0848381A2 disclose domain expansion ROM media with a domain expansion stack on an injection moulded substrate with smooth and rough areas to define the recorded information. Both solutions utilize etching through an e-beam mastered resist pattern in order to roughen areas on a glass master or substrate. The master may then be used to produce conventional stampers which are in turn used to produce substrates with roughened areas. The magnetic storage layer will exhibit an enhanced domain wall coercivity in areas where the substrate has been roughened, so that the magnetization in these areas will be more difficult to erase and much harder to overwrite in such a way as to preserve good read-back performance successfully.

One drawback of using the conventional glass master patterning and roughening techniques resides in that stampers are required which are expensive to produce and which have a limited lifetime. Furthermore, as bit sizes decrease to sub-100 nm dimensions, perfect replication of the roughened ROM data pattern will become technically more demanding. Moreover, patterning and roughening of individual substrates by irradiation of resist followed by etching is time consuming due to the serial writing process which may hinder the commercial viability of this technique.

It is therefore an object of the present invention to provide a more efficient solution for processing substrates of domain expansion ROM media.

This object is achieved by a processing method as claimed in claim 1 and a domain expansion storage medium as claimed in claim 13.

Accordingly, a high resolution non-contact technique can be used for processing the substrate of domain expansion storage media, to thereby enable improved replication of ROM data patterns. During ion beam projection the mask pattern may be reduced, so that the mask feature size can be larger than the required minimum medium feature size.

The processed surface may be the surface of the substrate as such or the surface of an additional layer of a seed metal or a dielectric material deposited on the substrate before performing the ion beam projection step, wherein the surface of the additional layer is processed in the processing step. In the latter case, better control of the surface processing may be allowed.

The surface processing may be a sputtering process to generate a pattern of roughened or smoothed areas at said exposed portions. Whether the exposed areas are roughened or smoothed depends upon the exposure time, energy and mass of the incident ions, and the material being exposed.

Additionally, the processing step may be adapted to modify optical properties at predetermined surface portions so as to define a track structure of the storage medium. Thereby, the land/groove track structure of conventional optical media can be replaced by a smooth/rough track structure. Specifically, a first mask may be used for forming the data pattern, while a second mask may be used for forming the track structure. The beam projection and processing steps may be performed at least two times for the track structure.

Furthermore, the beam projection and processing steps may be adapted to pattern embedded servo information into said surface. Consequently, also in this respect, corresponding land/groove structures of conventional optical disks can be dispensed with The focus of the at least one ion beam may be controlled so as to modify the roughness of the surface. Then, a first focus can be used for forming the data structure, while a second focus can be used for forming the servo pattern.

A whole disk is patterned in the ion beam projection and processing steps. Thereby, individual data, track and/or servo patterns can be written simultaneously in a short processing time.

The mask may be formed by an e-beam lithography and a subsequent semiconductor etching.

Further advantageous modifications are defined in the dependent claims.

In the following, the present invention will be described in greater detail on the basis of preferred embodiments with reference to the accompanying drawings, in which:

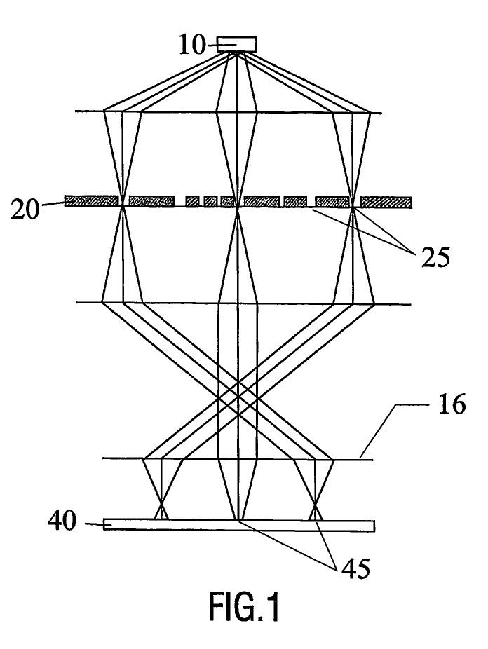

FIG. 1 shows a schematic diagram of an ion beam projection lithography arrangement which can be used for the present invention;

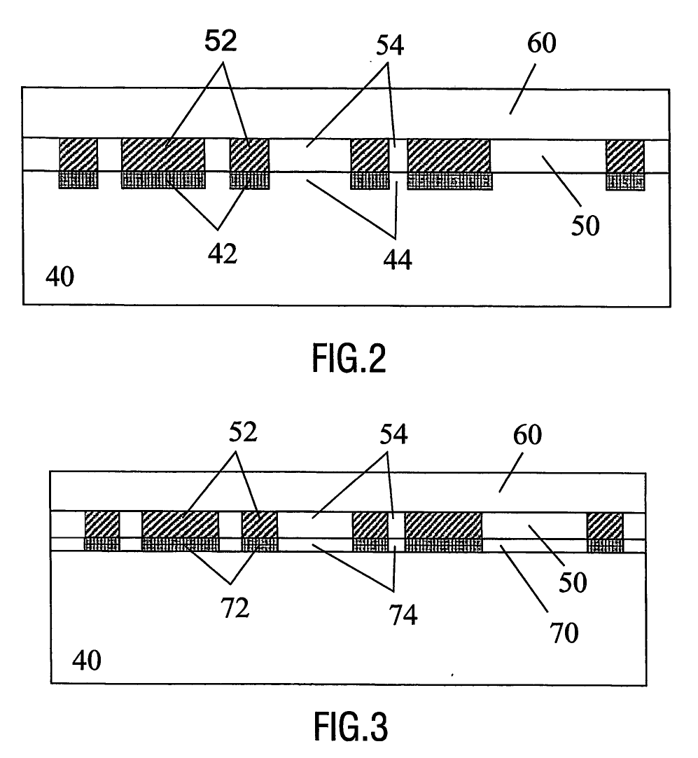

FIG. 2 shows a sectional view of a layer arrangement of a domain expansion storage medium according to a first preferred embodiment of the present invention;

FIG. 3 shows a sectional view of a layer arrangement of a domain expansion storage medium according to a second preferred embodiment of the present invention; and

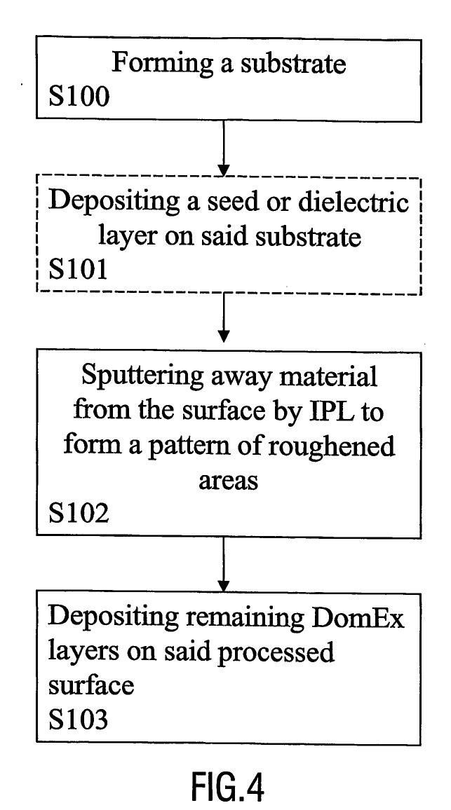

FIG. 4 shows a schematic flow diagram of a substrate processing method according to the preferred embodiments of the present invention.

The preferred embodiments will now be described on the basis of a domain expansion ROM disc, wherein a substrate is processed during manufacturing by using an ion beam projection lithography (IPL).

FIG. 1 schematically illustrates an ion beam projection lithography (IPL) arrangement or tool. In general, such an IPL tool is used for the formation of an image of a structured mask or stencil mask 20, i.e. a mask provided with openings 25 for passing a beam of ions, upon a substrate 40 of the domain expansion ROM disk and comprises an ion source 10 for generating the ion beam, the structured stencil mask 20 and an immersion lens 14 between the stencil mask 20 and the substrate 40. The immersion lens 14 serves to accelerate the ions to the desired final energy for structuring the substrate 40. Furthermore, a prelens 12 and a projection lens 16 can be provided also in the path of the ion beam. On the substrate 40, a demagnified pattern 45 can be obtained at a size depending on the projection parameters. The ion source 10 may be a helium (He) ion source for generating desired He ions. Further details of the IPL tool can be gathered from Kaesmaier et al., SPIE conference on Microlithography, Santa Clara, Calif. (2000).

According to the preferred embodiments, ion beam projection lithography (IPL) provides an alternative high resolution surface modification and/or patterning technique for processing the substrate 40. This technique has been used conventionally to pattern magnetic hard disk media, whereby the magnetic properties of the media are altered by ion implantation. If ions with the correct energy (momentum) are used, then it is also possible for material to be sputtered away from very localized areas of the bare substrate, thus leaving a pattern of roughened or smoothed areas. Subsequent deposition of a MAMMOS stack on this modified or patterned substrate will result in a DomEx ROM disk.

FIG. 2 shows a sectional view of a layer structure of the domain expansion ROM disk according to the first preferred embodiment. In general, the magneto-optical recording medium or disk for realizing super-resolution or domain expansion reading may be composed of any magnetic layer or film differing in the coercive force depending on the recorded information and possessing a relatively large magneto-optical effect. The recording information is expressed by roughening the recording domain portions to form rough areas 42 on the substrate 40, as compared with the remaining smooth areas 44. The coercive force begins to increase when the mean dimension of the roughness of the surface in the in-plane direction becomes about 10 nm or more, and the coercive force begins to increase when the mean dimension of the roughness of the surface in the perpendicular direction becomes about 3 nm or more. Hence, depending on the recording information, when a rare earth-transition metal (RE-TM) alloy magnetic storage layer 50 is formed on the substrate 40 having the rough areas 42 with mean roughness of the surface in the in-plane direction and perpendicular direction of 10 nm or more and 3 nm or more, respectively, and the smooth portions 44 with mean roughness of the surface in the in-plane direction and perpendicular direction of 10 nm or less and 3 nm or less, respectively, a magneto-optical recording medium possessing portions differing in the coercive force depending on the recording information is obtained. The storage layer 50 is covered by readout and dielectric layers 60 to form the required DomEx layer stack.

FIG. 3 shows a sectional view of a layer structure of the domain expansion ROM disk according to the second preferred embodiment. Here, a seed metal or dielectric layer 70 is first deposited on the substrate 40 and then roughened or patterned using IPL to form rough areas 72 and smooth areas 74 at the surface of the seed layer 70. This additional seed layer 70 may allow greater control of the roughness of the patterned areas.

In both preferred embodiments, it may also be possible to roughen the substrate 40 or the seed layer 70, respectively, by IPL to such an extent that the optical properties of the stack may be modified enough for detectable variations in reflectivity to occur. This may allow the land/groove track structure of conventional optical media to be replaced by a smooth/rough track structure, any loss in reflected light indicating track edges. By the use of suitable masks, it may be possible to “single” expose areas forming the ROM data pattern, and “double”, “triple” or “quadruple”, etc., expose areas forming the track structure by repeating the IPL roughening or patterning process for a corresponding number of times.

Alternatively, in both preferred embodiments, IPL may be used to pattern embedded servo information into the surface of the substrate 40 or the seed layer 70, also allowing the land/groove structure of conventional optical disks to be dispensed with. Such a servoing technique is similar to that used in hard disks.

Focussed ion beam equipment may also be used to modify the roughness of the substrate 40 or seed layer 70 in order to form ROM data, servo patterns and/or track patterns. However, the use of a single focussed ion beam that has to move across the whole substrate surface may take a prohibitively large amount of time and therefore be commercially unattractive.

The advantage if IPL is that it is a high resolution non-contact technique. Therefore, the perfect replication of ROM data patterns should be considerably eased. Furthermore, a whole small format disk may be patterned in one exposure with the individual data, track and/or servo patterns being written simultaneously in a number of seconds. The aim is to take advantage of the 300 mm wafer throughput of up to 50 wafers per hour, or more, at the 50 nm lithography node (i.e. resolution in terms of half pitches and feature sizes), over stitched 12.5 mm×12.5 mm fields. Assuming that the time required for exchanging and exposing the substrates is under 20 seconds, and that the area to be patterned lies within a 12.5 mm diameter circle, a throughput of 180 discs per hour could be achieved. Larger exposure fields may be accommodated, depending upon the level of pattern distortion at the disk edges that can be tolerated. Alternatively, by using multiple exposures of adjacent areas, larger disks may be patterned at the cost of disc throughput. During the IPL process a 150 mm SOI (Silicon On Insulator) stencil mask 20 pattern can be reduced e.g. by a factor of four during projection onto the substrate. Therefore, the minimum stencil mask 20 feature size may be larger than the required medium minimum feature (bit) size. The stencil mask 20 itself can be manufactured using e-beam lithography and semiconductor etching techniques.

In the following, a method of processing the substrate 40 of the domain expansion ROM disk is described with reference to the flow diagram of FIG. 4. According to FIG. 4, in step S100, the substrate 40 is first formed while use can be made, for example, of glass, polycarbonate, polymethyl methacrylate, resin of a thermoplastic origin, or the like. Then, in case of the structure of the second preferred embodiment, the seed or dielectric layer 70 is deposited on the substrate 40 in step S101. It is noted that step S101 is omitted in the first preferred embodiment. In step S102, material at the surface of the substrate 40 or the seed layer 70 is sputtered away by IPL to form a pattern of roughened areas 42, 72 so as to define domain portions in the subsequently deposited storage layer 50, and/or track and/or servo patterns. Finally, the remaining layer stack of the DomEx ROM disk is formed or deposited on the processed or roughened surface in step S103.

The magnetic storage layer 50 and the magnetic readout layer may be composed of any RE-TM compound having relatively high magneto-optical effects, such as TbFe, GdTbFe, TbFeCo, DyFe, GdDyFe, DyFeCo, GdDyFeCo, and NdTbFeCo, or a transition metal oxide and nitride compound film, a ferrite film, or a 3D transition metal magnetic film, including multilayers of such films.

The present invention can be applied to any domain expansion ROM medium, while the ion beam processing can be adapted to obtain any suitable surface structure of the substrate 40, seed layer 70 or other intermediate layer, which can be used to obtain optical or magnetic properties sufficient to define the proposed domain portions, track and/or servo patterns. The preferred embodiment may thus vary within the scope of the attached claims.

1. A method of processing a substrate for a domain expansion storage medium in which a magnetic wall is displaced in a readout layer to thereby enlarge a magnetic domain of a storage layer so as to reproduce an information indicated by said magnetic domain, said method comprising the steps of:
a) passing at least one beam of ions through a mask with a predetermined pattern so as to project said predetermined pattern towards said substrate;
b) processing a surface by said at least one beam of ions at exposed portions; and
c) depositing said storage layer above said processed surface so as to define magnetic domains of a data structure in said storage layer at portions corresponding to said exposed portions.

2. A method according to claim 1, further comprising an initial step of depositing an additional layer of a seed metal or a dielectric material on said substrate before performing said ion beam projection step, wherein the surface of said additional layer is processed in said processing step.

3. A method according to claim 1, wherein the surface of said substrate is processed in said processing step.

4. A method according to claim 1, wherein said surface processing is a sputtering process to generate a pattern of roughened or smoothed areas at said exposed portions.

5. A method according to claim 1, wherein said processing step is adapted to modify optical properties at predetermined surface portions so as to define a track structure of said storage medium.

6. A method according to claim 5, wherein a first mask is used for forming said data pattern and a second mask is used for forming said track structure, or vice versa.

7. A method according to claim 5, wherein said beam projection and processing steps are performed at least two times for said track structure.

8. A method according to claim 5, wherein said beam projection and processing steps are adapted to pattern embedded servo information into said surface.

9. A method according to claim 1, further comprising the step of controlling the focus of said at least one ion beam so as to modify the roughness of said surface.

10. A method according to claim 9, wherein a first focus is used for forming said data structure, while a second focus is used for forming a servo pattern.

11. A method according to claim 1, wherein a whole disk is patterned in said ion beam projection and processing steps.

12. A method according to claim 1, further comprising the step of forming said mask by an e-beam lithography and a subsequent semiconductor etching.

13. A domain expansion storage medium in which a magnetic wall is displaced in a readout layer to thereby enlarge a magnetic domain of a storage layer so as to reproduce the information indicated by said magnetic domain, said storage medium comprising an intermediate surface processed by ion beam projection lithography with a predetermined pattern to define at least one of a data pattern of said storage layer, a track pattern and a servo pattern.

14. A storage medium according to claim 13, wherein said processed intermediate surface corresponds to the surface of a substrate of said storage medium.

15. A storage medium according to claim 13, wherein said processed intermediate surface corresponds to the surface of a seed or dielectric layer deposited on a substrate of said storage medium.
